(19) United States
(12) Patent Application Publication
(10) Pub. No.: US 2009/0321218 A1
(43) Pub. Date: Dec. 31, 2009

(54) Vehicle Assembling Line System

(76) Inventor: Tomohiro Hase, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/084,965

(22) PCT Filed: Nov. 14, 2006
(86) PCT No.: PCT/JP2006/323068

§ 371 Date: May 11, 2009

(30) Foreign Application Priority Data
Nov. 16, 2005 (JP) 2005-332047

(51) Int. Cl. B62D 65/18

(52) U.S. Cl. 198/339.1

(57) ABSTRACT

A vehicle assembling line system 1 for supplying different types of vehicles, comprising a monocoque vehicle assembling line 100 and a frame vehicle assembling line 200. The conveying speeds of these assembling lines 100, 200 at any position are made changeable, and the conveying speed of vehicles when the vehicles are passed through the working areas 111, 211 of the assembling lines 100, 200 are set lower than the conveying speed of the vehicles when the vehicles are passed through those areas other than the working areas 111, 211. The length L1 of the working area 111 in the direction of the assembling line 100 and the length L2 of the working area 211 in the direction of the assembling line 200 are changed according to the number of vehicles supplied to the assembling lines 100, 200.

### FIELD OF THE ART OF THE INVENTION

The present invention relates to an art of a line assembling a vehicle. In more detail, the present invention relates to an art improving working efficiency of the line assembling the vehicles.

### BACKGROUND ART

Conventionally, there is well known a so-called mixed flow type vehicle assembling line that a plurality of vehicle assembling lines are provided closely and respective kind of vehicles are assembled on each of the vehicle assembling lines.

With regard to the general construction of such a mixed flow type vehicle assembling line, conveying speed of each of the vehicle assembling lines is synchronized and an operator moves suitably to the vehicle assembling line to which many vehicles are supplied so as to perform assembly work.

However, with regard to such a mixed flow type vehicle assembling line (hereinafter, referred to as “conventional mixed flow type vehicle assembling line”), the number of the vehicles conveyed along the vehicle assembling line is large in general. When tact time (time assigned to the assembly of one vehicle) is short, the frequency of the movement of the operator between the vehicle assembling lines assembling different types of vehicles may high, thereby reducing the working efficiency (productivity) in general.

That is because the shortening of the tact time increases the ratio of the time for the operator to move between the vehicle assembling lines (moving time) occupied to the whole working time since the moving time is fixed regardless of the change of the tact time.

When the supply of the vehicles is concentrated upon one assembling line, the tact time of said assembling line is extremely shortened. Accordingly, the assembly work may lag, thereby stopping the assembling line (the conveying of the vehicles). With regard to the conventional vehicle assembling line, when one assembling line is stopped, the other assembling lines are also stopped, thereby reducing the working efficiency (productivity) in general.

Furthermore, with regard to the conventional vehicle assembling line, the conveying speed of the vehicles must not be too high so as not to stop the vehicle assembling line even if the ratio of types of the vehicles is changed widely, whereby it is difficult to improve the working efficiency (productivity).

As a method solving such problems, for example, arts described in the patent literatures 1 to 4 are proposed.

With regard to the method described in the patent literature 1 (the Japanese Patent Laid Open Gazette 2002-79964), a plurality of types of vehicles are conveyed by one vehicle assembling line, and processes with large work man-hour are arranged adjacently to each other. The work man-hour of the processes with large work man-hour is calculated corresponding to the combination (arrangement) of the vehicles pending to the processes, and based on the calculated result, the conveying speed of the vehicle assembling line is adjusted.

The method described in the patent literature 1 is excellent in the point that the processes with large work man-hour, which are the most important factors determining the conveying speed of the vehicle assembling line, are not arranged dispersively but are arranged adjacently (intensively) on the vehicle assembling line so as to facilitate the improve of the conveying speed of the vehicle assembling line, thereby improving the working efficiency.

With regard to the method described in the patent literature 2 (the Japanese Patent No. 3079955), a vehicle assembling line is branched at its middle portion to a line assembling frame vehicles and a line assembling monocoque vehicles.

The method described in the patent literature 2 can treat vehicles widely different in work man-hour without stopping the vehicle assembling line or using a buffer while the part of the vehicle assembling line besides the part at which the actual assembly work is performed are constructed as one line.

With regard to the method described in the patent literature 3 (the Japanese Patent Laid Open Gazette Hei. 7-277239), a vehicle assembling line is branched at its middle portion to a plurality of branch lines and different types of vehicles are supplied to each branch line so as to be assembled. When the number of the vehicles supplied to the certain line is large, the vehicles are also supplied to another line which has a margin in process throughput.

With regard to the method described in the patent literature 3, the assemble work can be performed without stopping the vehicle assembling line even if the number of the vehicles supplied to the line treating the certain kind of the vehicles is large.

With regard to the method described in the patent literature 4 (the Japanese Patent Laid Open Gazette Hei. 6-35536), self-propelled conveying members traveling on one assembling line convey a plurality of types of workpieces, and the pitch of the conveying members (the distance between the conveying members traveling on the assembling line) is adjusted corresponding to the work man-hour of the mounted workpieces.

With regard to the method described in the patent literature 4, the vehicles different in the work man-hour can be treated on the same assembling line without changing the conveying speed.

However, with regard to the method described in the patent literature 1, the conveying speed may not be able to be changed depending on the combination (arrangement) of the types of vehicles conveyed along the vehicle assembling line.

With regard to the methods described in the patent literatures 2 and 3, the conveying speed of the vehicle on the assembling line is substantially fixed. Accordingly, it is necessary to make the branched part of the assembling line enough long or to provide a reserve branched line so as to deal with the case that the ratio of types of the vehicles supplied to the vehicle assembling line changes widely, whereby large installation area is required.

With regard to the method described in the patent literature 4, the difference of the work man-hour is adjusted by the pitch of the conveying members. Accordingly, when the ratio of the vehicles requiring large work man-hour occupied to the vehicles supplied to the vehicle assembling line increases, the number of the vehicles on the vehicle assembling line reduces. Accordingly, if circumstances require, it is necessary to provide a buffer in the upper part of the vehicle assembling line (the part supplying the vehicles to the vehicle assembling line).

In consideration of the above-mentioned problems, the present invention provides a vehicle assembling line system dealing with the change of the ratio of types of the vehicles supplied to the vehicle assembling line (the ratio of the produced vehicles) flexibly so as to achieve high working efficiency (productivity).

### SUMMARY OF THE INVENTION

The above-mentioned problems are solved by the following means according to the present invention.

With regard to a vehicle assembling line system having a plurality of assembling lines, each of the lines comprising a conveying route passing through working area at which predetermined assembly work to a vehicle is performed and an conveying equipment conveying the vehicle along the conveying route, and supplying different types of vehicles to the assembling lines,

the conveying equipment can change conveying speed of the vehicle at an optional position on the assembling line,

the conveying speed of the vehicle at the time of passing through the working area is set lower than the conveying speed of the vehicle at the time of passing through areas except for the working area, and

length of the working area along the assembling line is changed corresponding to number of the vehicles supplied to the assembling line.

Number of a plurality of the assembling lines is two, and a monocoque vehicle is supplied to one of the two assembling lines and a frame vehicle is supplied to the other assembling line.

The conveying equipment comprises

a track member provided along the conveying route,

a plurality of vehicle support members which support the vehicles and are movable along the track member while engaged with the track member, and

a plurality of friction drive members which are provided at predetermined distances along the track member and rotatively driven while touching the vehicle support members so as to push the vehicle support members along conveying direction of the conveying route, and whose rotary speed can be changed at each of the provided positions.

The present invention has below effects.

Namely, even if the ratio of types of the vehicles supplied to the vehicle assembling line changes widely, the change can be dealt with easily and flexibly only by the length of the working area of each assembling line along the assembling line, thereby improving the productivity.

The layout of each of the working areas can be constructed suitably for the vehicles supplied thereto. Therefore, the efficiency of the assembly work can be improved so as to improve the productivity.

The conveying speed of the vehicles at an optional position on each of the vehicle assembling lines can be changed easily.

### BRIEF DESCRIPTION OF THE DRAWINGS

FIG. 1 is a drawing of entire construction of a vehicle assembling line system according to the present invention.

FIG. 2 is also a drawing of entire construction of the vehicle assembling line system according to the present invention.

### THE BEST MODE OF EMBODIMENT OF THE INVENTION

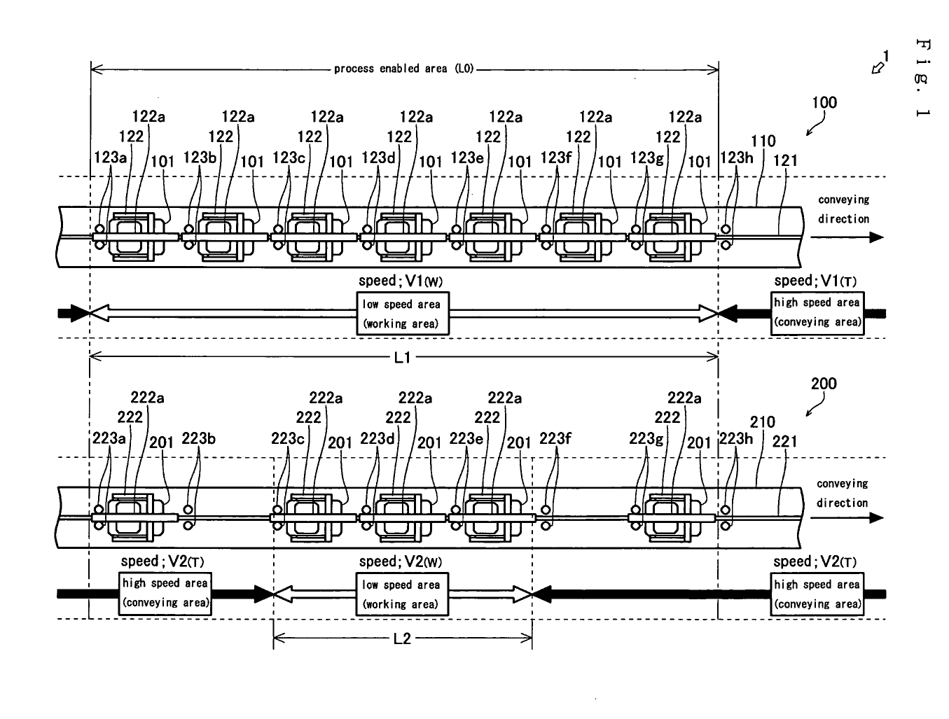

Explanation will be given on construction of a vehicle assembling line system 1, which is an embodiment of a vehicle assembling line system according to the present invention, referring to FIG. 1.

The “vehicle assembling line system” according to the present invention performs predetermined assembling work of vehicles while conveying the vehicles.

The “vehicles” according to the present invention include passenger cars (sedans, minivans and vans), transport vehicles (tracks, trailers and the like) and various types of working vehicles.

The vehicle assembling line system 1 comprises a monocoque vehicle assembling line 100 and a frame vehicle assembling line 200.

Namely, with regard to the vehicle assembling line system 1, different types of vehicles are respectively supplied to two assembling lines, the monocoque vehicle assembling line 100 and the frame vehicle assembling line 200.

The “different types of vehicles” according to the present invention includes not only vehicles different in division, such as passenger cars, transport vehicles and working vehicles, but also vehicles of same division and different in body structure, such as monocoque vehicles and frame vehicles, and vehicles of same division and same body structure and different in type (external shape).

The vehicle assembling line system 1 in this embodiment comprises two assembling lines (the monocoque vehicle assembling line 100 and the frame vehicle assembling line 200). However, the vehicle assembling line system according to the present invention is not limited thereto and a system comprising three or more assembling lines takes substantially the same effect.

Explanation will be given on the monocoque vehicle assembling line 100.

The monocoque vehicle assembling line 100 is an embodiment of a vehicle assembling line according to the present invention and performs predetermined assembling work of monocoque vehicles 101 which are vehicles of monocoque structure while conveying the monocoque vehicles 101.

The monocoque vehicle assembling line 100 comprises a conveying route 110 and a conveying equipment 120.

Explanation will be given on the conveying route 110.

The conveying route 110 is an embodiment of a conveying route according to the present invention, and constitutes a route conveying the monocoque vehicles 101 and passes through a working area 111.

In the working area 111, an engine (not shown) is mounted upward to each of the monocoque vehicles (more strictly, chassis of each of the monocoque vehicles) 101. An operator mounts the engine upward to each of the monocoque vehicles 101 passing through the working area 111.

The “working area” according to the present invention is not limited to the area in which the engines are mounted as this embodiment, and includes widely an area for predetermined assembly work (attachment work of base carriers such as suspensions, electric equipments, trim parts such as bumpers or side moldings, or the like) to vehicles.

The conveying route 110 in this embodiment passes through one working area 111. However, the conveying route according to the present invention is not limited thereto. The conveying route constructed to pass through a plurality of working areas takes substantially the same effect. The same is substantially said of a later-discussed conveying route 210.

Explanation will be given on the conveying equipment 120.

The conveying equipment 120 is an embodiment of a conveying equipment according to the present invention, and conveys the monocoque vehicles 101 along the conveying route 110.

The conveying equipment 120 mainly comprises a rail 121, hangers 122 and friction drives 123a, 123b and the like.

The rail 121 is an embodiment of a track member according to the present invention, and is a rod-like member provided along the conveying route 110. The rail 121 has predetermined height from a floor surface of the conveying route 110.

Each of the hangers 122 is an embodiment of a vehicle support member according to the present invention, and is a structure body formed by joining steel pipes or the like with each other by welding or the like. Each of the hangers 122 supports the monocoque vehicle 101 by anchoring it. The hangers 122 can be moved (slid) along the rail 121 while hung by the rail 121 and engaged with the rail 121.

With regard to the conveying equipment 120 in this embodiment, a plurality of the hangers 122 engage with the rail 121. However, the number of the vehicle support members engaged with the track member of the conveying equipment according to the present invention is not limited and is selectable suitably.

The friction drives 123a, 123b and the like are an embodiment of friction drive members according to the present invention, and are provided along the rail 121 at predetermined intervals. Since the friction drives 123a, 123b and the like are constructed substantially similarly to each other, only the friction drives 123a will be explained below and explanation of the friction drives 123b, 123c and the like is omitted.

Each of the friction drives 123a in this embodiment are substantial circular cylindrical members rotatively driven by motors. A ring member formed by rubber is engaged with the outer perimeter of the friction drive 123a.

The friction drives 123a are a pair of rollers. The friction drives 123a are arranged to face each other with the rail 121 between, and each of the friction drives 123a is arranged at a “predetermined distance” from the side surface of the rail 121. The predetermined distance between the friction drive 123a and the rail 121 is determined so that the friction drive 123a touches an engagement part 122a, which is the part of the hanger 122 engaged with the rail 121, when the engagement part 122a enters the position between the rail 121 and the friction drive 123a.

When the friction drives 123a are rotatively driven while touching the engagement part 122a of the hanger 122, the hanger 122 is pushed along the conveying direction of the conveying route 110 (rightward in FIG. 1).

Each of the friction drives 123a, 123b and the like respectively has different motor as a drive source, and by adjusting the rotary speed of the motor, the rotary speed of each of the friction drives 123a, 123b and the like can be changed at each of the provided positions.

Consequently, the conveying equipment 120 can change the conveying speed of the monocoque vehicles 101 (more strictly, the monocoque vehicles 101 respectively supported by the hangers 122) at an optional position on the monocoque vehicle assembling line 100 (more strictly, at each of the positions at which the friction drives 123a, 123b and the like are provided).

The friction drives 123a, 123b and the like in this embodiment are constructed so that the distance between the rollers (the predetermined distance) is slightly shorter than the length of the engagement part 122a of the hanger 122, whereby the hanger 122 always touches one of the friction drives 123a, 123b and the like. However, the friction drive members according to the present invention are not limited thereto, and the vehicle support member engaged with the track member may alternatively touch two or more friction drive members always.

The conveying equipment 120 of the vehicle assembling line system 1 in this embodiment comprises the rail 121 having the predetermined height from the floor surface of the conveying route 110, the hangers 122 hung by the rail 121 so as to be movable along the rail 121 while engaged with the rail 121, and the friction drives 123a, 123b and the like whose rotary speed can be changed at each of the provided positions. However, the conveying equipment according to the present invention is not limited thereto. For example, the conveying equipment comprising a conveying dolly, which can travel along the conveying route while carrying the vehicle to be assembled thereon and can change its traveling speed at an optional position on the conveying route, takes substantially the same effect.

Explanation will be given on the frame vehicle assembling line 200.

The frame vehicle assembling line 200 is an embodiment of a vehicle assembling line according to the present invention, and performs predetermined assembly work to frame vehicles 201, which are vehicles having frame structure, while conveying the frame vehicles 201.

The frame vehicle assembling line 200 comprises the conveying route 210 and a conveying equipment 220.

Explanation will be given on the conveying route 210.

The conveying route 210 is an embodiment of a conveying route according to the present invention, and constitutes a route conveying the frame vehicles 201 and passes through a working area 211.

In the working area 211, a body (not shown) as an upper structure body of the frame vehicle is mounted upward to each of the frame vehicles (more strictly, a frame as a lower structure body of the frame vehicle on which an engine is mounted) 201. An operator mounts the engine upward to each of the frame vehicles 201 passing through the working area 211.

Explanation will be given on the conveying equipment 220.

The conveying equipment 220 is an embodiment of a conveying equipment according to the present invention, and conveys the frame vehicles 201 along the conveying route 210.

The conveying equipment 220 mainly comprises a rail 221, hangers 222 and friction drives 223a, 223b and the like.

Since the conveying equipment 220 in this embodiment is constructed substantially similarly to the conveying equipment 120 fundamentally, detailed explanation of the conveying equipment 220 is omitted.

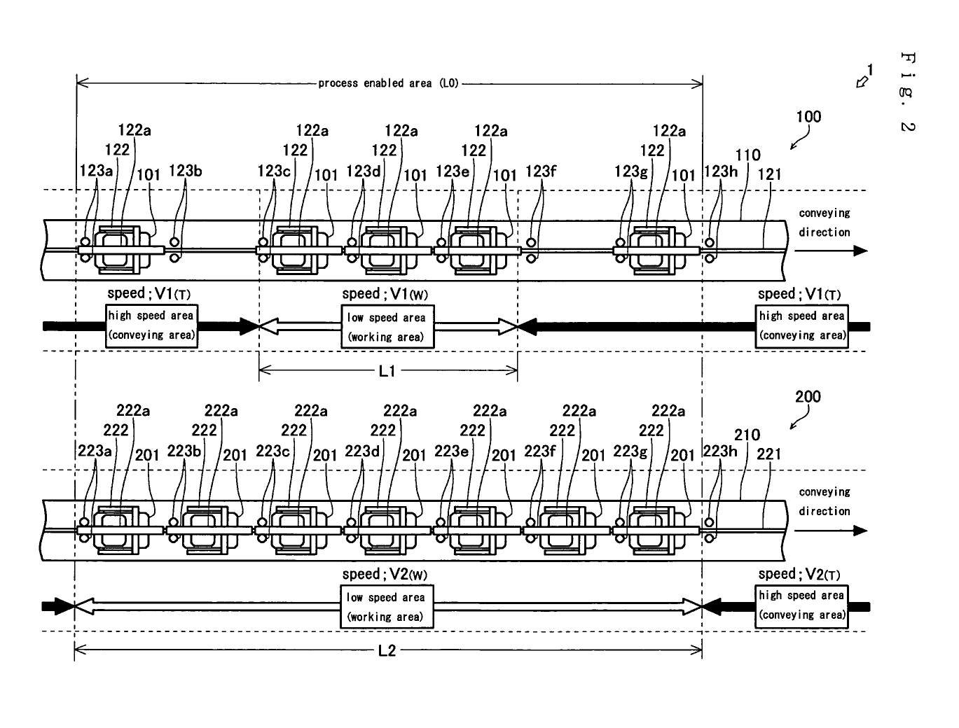

Explanation will be given on a method determining the conveying speed of the monocoque vehicle assembling line 100 of the vehicle assembling line system 1 and length L1 of the working area 111 along the monocoque vehicle assembling line 100 referring to FIGS. 1 and 2.

In below explanation, “the length L1 of the working area 111 along the monocoque vehicle assembling line 100” is briefly referred to as “the length L1 of the working area 111”.

As shown in FIG. 1, the conveying route 110 of the monocoque vehicle assembling line 100 passes through the process enabled area having predetermined length, and the working area 111 is set within the process enabled area (so as not to be protruded from the process enabled area).

The “process enabled area” is an area in which the working area can be set and is normally controlled so as not to set another working area therein and not to arrange an obstacle or the like obstructing the set of the working area therein.

With regard to the monocoque vehicle assembling line 100, conveying speed V1(W) of the monocoque vehicles 101 at the time of passing through the working area 111 is normally set lower than conveying speed V1(T) of the monocoque vehicles 101 at the time of passing through areas except for the working area 111.

That is because of below reasons. Since the areas except for the working area 111 in the monocoque vehicle assembling line 100 are not used directly in work of an operator, it is preferable to set the conveying speed V1(T) as high as possible so as to improve the conveying capacity of the monocoque vehicle assembling line 100. Since the working area 111 is used directly in the work of the operator, it is preferable to set the conveying speed V1(W) as low as possible in consideration of the workability within the range not to influence widely the conveying capacity of the monocoque vehicle assembling line 100 (not to reduce widely the conveying capacity).

On the other hand, the time required for the operator to mount the engine on the monocoque vehicle 101 must be shorter than the time required for the monocoque vehicle 101 to pass through the inside of the working area 111 (L1/{V1(W)}). That is because if the operator operates in the areas except for the working area 111, the monocoque vehicle assembling line 100 may be stopped.

“The time required for the operator to mount the engine on the monocoque vehicle 101” includes not only the time actually required for the operator to mount the engine on the monocoque vehicle 101 but also the time required for the operator after finishing the work to move to another monocoque vehicle 101 entering the working area 111 so as to start next work.

When the number of the monocoque vehicles 101 entering the working area 111 per unit time, that is, the number of the monocoque vehicles 101 supplied from the upper process to the monocoque vehicle assembling line 100 per unit time is increased, the length L1 of the working area 111 is extended as shown in FIG. 1 (in the case of FIG. 1, the length L1 of the working area 111 is substantially the same as length L0 of the process enabled area along the monocoque vehicle assembling line 100).

Accordingly, a plurality of operators can mount the engines to the monocoque vehicles 101 in the same working area 111, whereby the throughput of the working area 111 is improved.

To the contrary, when the number of the monocoque vehicles 101 entering the working area 111 per unit time, that is, the number of the monocoque vehicles 101 supplied from the upper process to the monocoque vehicle assembling line 100 per unit time is reduced, the length L1 of the working area 111 is shortened as shown in FIG. 2 (in the case of FIG. 2, the length L1 of the working area 111 is set to about 3/7 of the length L0 of the process enabled area along the monocoque vehicle assembling line 100).

Accordingly, the average conveying speed of the monocoque vehicle assembling line 100 can be increased while the operators of minimum number mount the engines to the monocoque vehicles 101 in the working area 111, whereby the throughput of the working area 111 is improved (more strictly, the area, in which the monocoque vehicle assembling line 100 is operated at the conveying speed V1(W) though the operators don't work, can be reduced to the utmost so as to avoid waste).

Since vehicles of the same kind are supplied to the same assembling line, the work (production) can be performed without changing the arrangement of the vehicles.

Furthermore, in the case that vehicles are branched for every kind of the vehicle and supplied to the corresponding vehicle assembling lines at the upper side of the vehicle assembling line system and the vehicles passing through the vehicle assembling lines are joined at the lower side of the vehicle assembling line system, the time from the branching to the joining of each line can be equalized.

The method determining the conveying speed of the frame vehicle assembling line 200 of the vehicle assembling line system 1 and length L2 of the working area 211 along the frame vehicle assembling line 200 is substantially the same as “the method determining the conveying speed of the monocoque vehicle assembling line 100 of the vehicle assembling line system 1 and length L1 of the working area 111 along the monocoque vehicle assembling line 100”.

With regard to the frame vehicle assembling line 200, conveying speed. V2(W) of the monocoque vehicles 201 at the time of passing through the working area 211 is normally set lower than conveying speed V2(T) of the monocoque vehicles 101 at the time of passing through areas except for the working area 211. V2(W) may be either equal to V1(W) or different from V1(W), and V2(T) may be either equal to V1(T) or different from V1(T).

As mentioned above, with regard to the vehicle assembling line system 1 having the monocoque vehicle assembling line 100 comprising the conveying route 110 passing through the working area 111 so as to mount the engines to the monocoque vehicles 101 and the conveying equipment 120 conveying the monocoque vehicles 101 along the conveying route 110, and the frame vehicle assembling line 200 comprising the conveying route 210 passing through the working area 211 so as to mount the body to the frame vehicles 201 and the conveying equipment 220 conveying the frame vehicles 201 along the conveying route 210, and supplying the monocoque vehicles 101 and the frame vehicles 201 which are different types of vehicles to a plurality of the assembling lines (the monocoque vehicle assembling line 100 and the frame vehicle assembling line 200),

the conveying equipment 120 can change conveying speed of the monocoque vehicles 101 at an optional position on the assembly monocoque vehicle assembling line 100, and the conveying equipment 220 can change conveying speed of the frame vehicles 201 at an optional position on the frame vehicle assembling line 200,

the conveying speed V1(W) of the monocoque vehicles 101 at the time of passing through the working area 111 is set lower than the conveying speed V1(T) of the monocoque vehicles 101 at the time of passing through areas except for the working area 111 in the monocoque vehicle assembling line 100, and the conveying speed V2(W) of the frame vehicles 201 at the time of passing through the working area 211 is set lower than the conveying speed V2(T) of the frame vehicles 201 at the time of passing through areas except for the working area 211 in the frame vehicle assembling line 200, and

the length L1 of the working area 111, through which the monocoque vehicle assembling line 100 passes, along the monocoque vehicle assembling line 100 is changed corresponding to number of the monocoque vehicles 101 supplied to the monocoque vehicle assembling line 100, and the length L2 of the working area 211, through which the frame vehicle assembling line 200 passes, along the frame vehicle assembling line 200 is changed corresponding to number of the frame vehicles 201 supplied to the frame vehicle assembling line 200.

Accordingly, even if the ratio of the numbers of the monocoque vehicles 101 supplied to the monocoque vehicle assembling line 100 and the number of the frame vehicles 201 supplied to the frame vehicle assembling line 200, that is, the ratio of types of the vehicles supplied to the vehicle assembling line is changed widely, the change can be dealt with easily and flexibly only by the length L1 of the working area 111 and the length L2 of the working area 211.

The above-mentioned “dealing easily and flexibly” means “preventing the stop of the monocoque vehicle assembling line 100 or the frame vehicle assembling line 200 caused by the lag of the assembly work, and improving the productivity (reducing the loss) by reducing to the utmost the area at which the vehicles are conveyed at the conveying speed of the working time (V1(W) or V2(W)) though any operator does not works thereat”.

The monocoque vehicle assembling line 100 and the frame vehicle assembling line 200 can set the conveying speed at the time of passing through the working area (V1(W) and V2(W)) and the conveying speed at the time of passing through areas except for the working area (V1(T) and V2(T)) respectively independently. Accordingly, the average conveying speed of each of the assembling lines, that is, the working efficiency of each of the assembling lines can be improved without influenced by the working state of the other assembling lines.

Furthermore, since the same kind of vehicles are conveyed to the same assembling line, an operator can repeat the same work in the same working area when the ratio of types of the vehicles supplied to the vehicle assembling line system 1 is not changed at the same duty (working period).

With regard to the vehicle assembling line system 1, the part corresponding to the working area 111 of the monocoque vehicle assembling line 100 (process enabled area) and the part corresponding to the working area 211 of the frame vehicle assembling line 200 (process enabled area) are provided in parallel with each other and separately for the “predetermined distance”.

Accordingly, even if the ratio of types of the vehicles supplied to the vehicle assembling line system 1 is changed at the same duty (working period), an operator can moved to the working area 111 of the other assembling line (from the working area 111 to the working area 211 or from the working area 211 to the working area 111) for a short time (the time for the movement of the operator which is not related to the assembly work directly can be reduced).

With regard to this embodiment, the distance between the part corresponding to the working area 111 of the monocoque vehicle assembling line 100 (process enabled area) and the part corresponding to the working area 211 of the frame vehicle assembling line 200 (process enabled area) is about 4 meter. However, the present invention is not limited thereto and the “predetermined distance” may be in a range from several meter to about dozen meter.

The vehicle assembling line system 1 has two assembling lines comprising the monocoque vehicle assembling line 100 and the frame vehicle assembling line 200, and

the monocoque vehicles 101 are supplied to the monocoque vehicle assembling line 100, and the frame vehicles 201 are supplied to the frame vehicle assembling line 200.

Accordingly, the monocoque vehicles 101 and the frame vehicles 201 which are different from each other widely at the details of assembly work can be dealt with by different assembling lines respectively, and the layout of each of the working areas 111 and 211 can be constructed suitably for the vehicles supplied thereto. Therefore, the efficiency of the assembly work can be improved so as to improve the productivity.

The conveying equipment 120 of the monocoque vehicle assembling line 100 of the vehicle assembling line system 1 comprises

the rail 121 provided along the conveying route 110,

the hangers 122 supporting the monocoque vehicles 101 and being movable along the rail 121 while engaged with the rail 121, and

the friction drives 123a, 123b and the like provided along the rail 121 at predetermined intervals and rotatively driven while touching the hanger 122 so as to push the hanger 122 along the conveying direction of the conveying route 110, and whose rotary speed can be changed at each of the provided positions.

The conveying equipment 220 of the frame vehicle assembling line 200 of the vehicle assembling line system 1 comprises

the rail 221 provided along the conveying route 210,

the hangers 222 supporting the frame vehicles 201 and being movable along the rail 221 while engaged with the rail 221, and

the friction drives 223a, 223b and the like provided along the rail 221 at predetermined intervals and rotatively driven while touching the hanger 222 so as to push the hanger 222 along the conveying direction of the conveying route 210, and whose rotary speed can be changed at each of the provided positions.

Accordingly, the conveying speed of the monocoque vehicles 101 at an optional position on the monocoque vehicle assembling line 100 and the conveying speed of the frame vehicles 201 at an optional position on the frame vehicle assembling line 200 can be changed easily.

### POSSIBILITY OF THE INDUSTRIAL UTILIZATION

The present invention is widely applicable to a line assembling a vehicle.

1. A vehicle assembling line system having a plurality of assembling lines, each of the lines comprising a conveying route passing through working area at which predetermined assembly work to a vehicle is performed and an conveying equipment conveying the vehicle along the conveying route, and supplying different types of vehicles to the assembling lines, characterized in that:
the conveying equipment can change conveying speed of the vehicle at an optional position on the assembling line;
the conveying speed of the vehicle at the time of passing through the working area is set lower than the conveying speed of the vehicle at the time of passing through areas except for the working area; and
length of the working area along the assembling line is changed corresponding to number of the vehicles supplied to the assembling line.

2. The vehicle assembling line system as set forth in claim 1, wherein
number of a plurality of the assembling lines is two, and
a monocoque vehicle is supplied to one of the two assembling lines, and a frame vehicle is supplied to the other assembling line.

3. The vehicle assembling line system as set forth in claim 1 or 2, wherein the conveying equipment comprises:
a track member provided along the conveying route;
a plurality of vehicle support members which support the vehicles and are movable along the track member while engaged with the track member; and
a plurality of friction drive members which are provided at predetermined distances along the track member and rotatively driven while touching the vehicle support members so as to push the vehicle support members along conveying direction of the conveying route, and whose rotary speed can be changed at each of the provided positions.
